(19) United States
(12) Patent Application Publication
(10) Pub. No.: US 2013/0065499 A1
(43) Pub. Date: Mar. 14, 2013

(54) AIR INTAKE STRUCTURE

(71) Applicant: Neil Patterson, Berkshire (GB)

(72) Inventor: Neil Patterson, Berkshire (GB)

(21) Appl. No.: 13/634,637

(22) PCT Filed: Mar. 17, 2011
(86) PCT No.: PCT/EP2011/054078

§ 371 Date: Oct. 2, 2012

(30) Foreign Application Priority Data
Mar. 17, 2010 (GB) 1004451.9

(51) Int. Cl. B60H 1/00

(52) U.S. Cl. CPC B60H 1/00457
USPC 454/152

(57) ABSTRACT

An air intake system for a vehicle, the system comprising a body panel having a pair of opposed walls defining a plenum therebetween, the walls being attached together in such a way as to structurally stiffen the body panel, and the plenum having an air intake for admitting air into the plenum and an air outlet for supplying air to an air handling system of the vehicle.

### CROSS REFERENCE TO RELATED APPLICATIONS

This application is a U.S. National Phase of International Application No. PCT/EP2011/054078 filed on Mar. 17, 2011, which claims priority to and the benefit of United Kingdom Patent Application No. GB1004451.9 filed on Mar. 17, 2010, the entire contents of which are incorporated herein by reference.

### FIELD OF INVENTION

This invention relates to air intake systems for vehicles, and especially but not exclusively to intake systems for serving vehicles' HVAC (heating, ventilation and air conditioning) systems.

### BACKGROUND OF THE INVENTION

In order to refresh the air in a vehicle's cabin it is necessary to draw air from outside the vehicle and introduce it into the cabin. Normally the outside air is captured at an intake, passes through one or more filters which remove debris and particles, passes through a heater matrix or an air conditioning unit and then runs through a duct to vents in the walls of the cabin.

FIG. 1 illustrates one common design of HVAC intake system for a motor car. The car comprises a cabin 1 which is separated from an engine bay 2 by a bulkhead 3. A windscreen or windshield 4 defines part of the front of the cabin. A bonnet or hood 5 closes the top of the engine bay. Inlet air for the car's HVAC system is captured at a channel 6 between the windscreen and the rear edge of the bonnet. At the intake the air passes through a grille 7, which filters out large debris such as leaves, and then to an air conditioning pack 8. The air conditioning pack dries the air and heats or cools it to a desired temperature. The conditioned air passes through a duct 9 which runs through the bulkhead 3 to a vent 10 in a panel near the driver. The air conditioning pack includes a blower 10 which can force air through the system. The air conditioning pack operates under the control of the driver.

The air intake could be in any of a range of locations. In some vehicles the intake is located in the upper surface of the bonnet and the inlet air passes through the bonnet to reach the air conditioning pack.

In order for the HVAC system to work effectively the inlet system preferably presents the air to the air conditioning pack with certain characteristics. These will be described below.

First, the inlet system is preferably configured so that excessive amounts of moisture do not reach the air conditioning pack. If there is precipitation in the ambient air then that could be drawn in with the inlet air, and if the vehicle is splashed, for example by a passing vehicle driving through a puddle, then a significant body of water could be thrown into the inlet system. One option to inhibit the problems of water ingestion is to locate the intake where it is unlikely to be splashed. However, in an extreme situation virtually any location that is not heavily protected or raised up (e.g. by a snorkel) can be splashed. Another way to extract water is by passing the air though a chamber in which excess water can be caught. If the chamber is small then its ability to catch water will not be great unless the air is made to negotiate a labyrinthine path in the chamber; but this type of path resists air flow and so makes it more difficult for air to be drawn through the intake system. Alternatively, if the chamber is large then it occupies space in the vehicle and adds weight.

Second, the inlet system is preferably configured so as to avoid sudden changes in the pressure of the air incoming to the air conditioning pack. If the intake is located at a region on the vehicle that experiences turbulence whilst the vehicle is moving then the pressure in the air delivery system can fluctuate. This is uncomfortable for the driver and can cause the air conditioning pack to work less efficiently. Hence, in FIG. 1 channel 6 is located in a region where substantially little buffeting turbulence would be expected. An alternative option is to locate the intake at a location where it faces directly into the oncoming airstream when the vehicle is moving. However, this has the disadvantage that when the car is moving quickly the air that is delivered to the air conditioning pack could be under considerable static pressure. A further option is to provide a plenum between the inlet and the air conditioning pack, in which any pressure waves in the incoming air can be smoothed out. Such a plenum is shown at 12 in FIG. 1. The provision of a dedicated plenum in this way occupies space in the vehicle and adds weight, even if it might also function to assist the extraction of water from the air. As an example, the Mercedes-Benz McLaren SLR has a plenum in the form of a box that hangs from a relatively small region of the bonnet into the engine space and has drain holes to allow water to escape.

A further consideration in modern vehicle design is the desirability of providing protection for pedestrians who might be struck by the vehicle. Various mechanisms are used to provide this protection. Portions of the bodywork can be made less rigid. Commonly the bonnet is attached to the vehicle via deformable hinges or shear pins which allow the bonnet to move relative to the rest of the vehicle in the event of a collision with a pedestrian.

There is a need for an air intake system for a vehicle which addresses the issues discussed above.

According to the present invention there is provided an air intake system for a vehicle, the system comprising a body panel having a pair of opposed walls defining a plenum therebetween, the walls being attached together in such a way as to structurally stiffen the body panel, and the plenum having an air intake for admitting air into the plenum and an air outlet for supplying air to an air handling system of the vehicle.

The body panel can have a front edge, a rear edge and side edges extending between the front and rear edges. Preferably the plenum comprises at least two longitudinal channels extending in a direction between the front and rear edges and a lateral channel interconnecting the longitudinal channels. Preferably the lateral channel interconnects the longitudinal channels at the ends of the longitudinal channels nearest the front edge. Preferably there is a drain hole in the plenum at a point near the front edge.

Preferably the body panel has an exterior face and the air intake is located in a part of the body panel other than the exterior face. Preferably the air intake is located in a side wall of the plenum.

Preferably the walls define a major sheet, a minor sheet generally parallel to a general plane of the major sheet and webs extending between the major sheet and the minor sheet in a direction out of a general plane of the major sheet, and wherein the air intake is located in one or more of the webs. Preferably the air intake is inboard of the periphery of the major sheet.

The body panel could form a part of the vehicle's exterior. The body panel could be a bonnet of the vehicle.

Preferably the body panel is formed of sheet material and the air intake is formed of one or more apertures through the sheet material, the apertures providing for controlled deformability of the bonnet in a crash. Suitably the bonnet is mounted at the vehicle by means of one or more hinges which are not designed to fail or deform in the event of a collision with a pedestrian, the apertures instead being configured to plastically deform in the event of such a collision.

Preferably the bonnet is mounted on the vehicle so that when the vehicle is in its running configuration the longitudinal channels slope down from the rear of the bonnet to the front. Preferably the air outlet is near the rear of the bonnet. Preferably the bonnet is mounted on the vehicle so that when the vehicle is in its running configuration the air inlet is not visible from the exterior of the vehicle.

### DESCRIPTION OF THE DRAWINGS

The present invention will now be described by way of example with reference to the accompanying drawings.

FIG. 1 is a longitudinal cross-section through the forward part of a prior art vehicle.

FIG. 2 shows the forward part of a vehicle with its bonnet open, exposing a compartment under the bonnet.

FIG. 3 is a lateral cross-section through the upper part of the vehicle of FIG. 2 on the line A-A′ with the bonnet in the closed configuration.

FIG. 4 is a longitudinal cross-section through the upper forward part of the vehicle of FIG. 2 on the line B-B′ with the bonnet in the closed configuration.

FIG. 5 is a longitudinal cross-section through the forward part vehicle of FIG. 2 with the bonnet in the closed configuration.

FIG. 6 is a side view of part of the bonnet of the vehicle of FIG. 2.

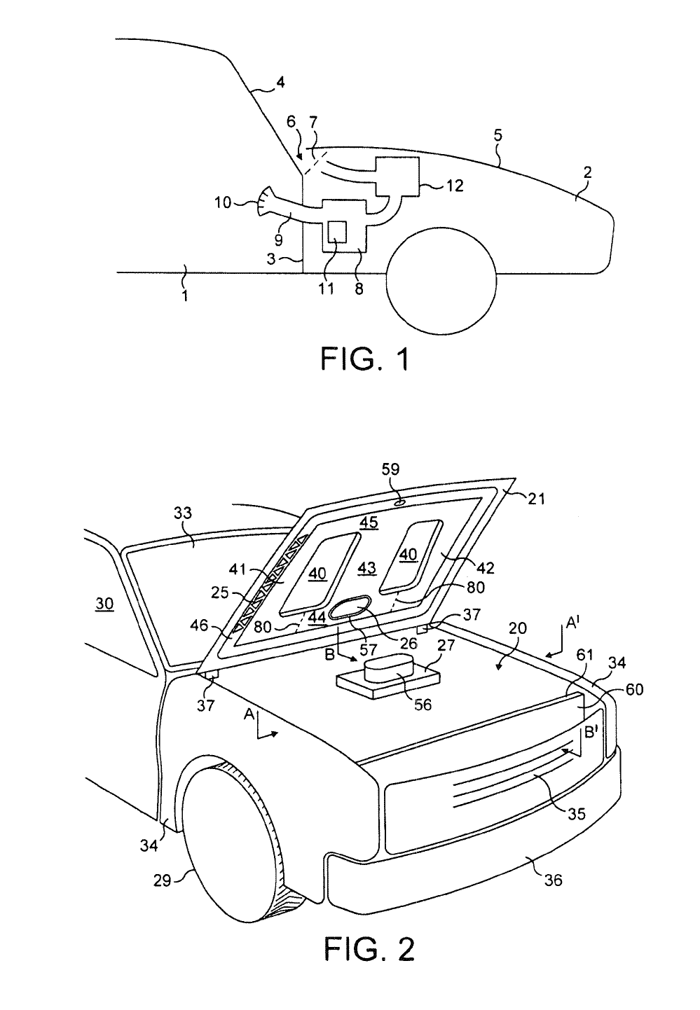

### DETAILED DESCRIPTION OF THE DRAWINGS

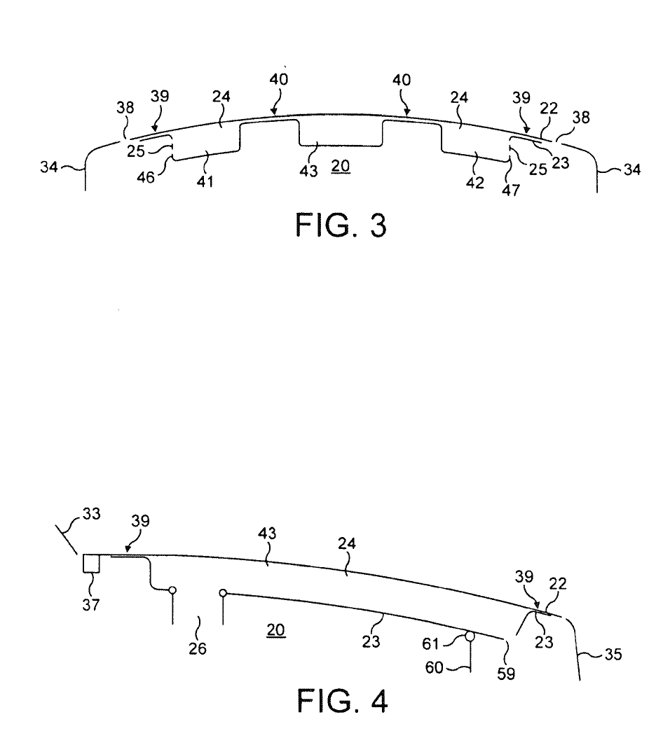

The vehicle of FIGS. 2 to 6 has a front compartment 20. If the vehicle is front-engined then the compartment 20 could contain the engine. Otherwise, the compartment could be available for storage of luggage and the like. The front compartment can be covered by a bonnet or hood 21. The bonnet is formed of two sheets of material 22, 23 (see FIGS. 3 and 4) which are clinched or bonded together leaving a cavity 24 between them. The cavity has air intakes 25 along its outer sides and an air outlet 26 in its lower wall 23. Downstream of the air outlet 26 is an air handling system including an air conditioning pack 27. The cavity is configured to act as a plenum to buffer against sudden pressure changes in the air provided to an air handling system and is configured to promote the extraction of water from air that is drawn into the system. In addition, the walls that define the cavity contribute to the structural strength of the bonnet, avoiding the need for additional bonnet stiffening means, and also allow the crash-worthiness of the bonnet to be enhanced.

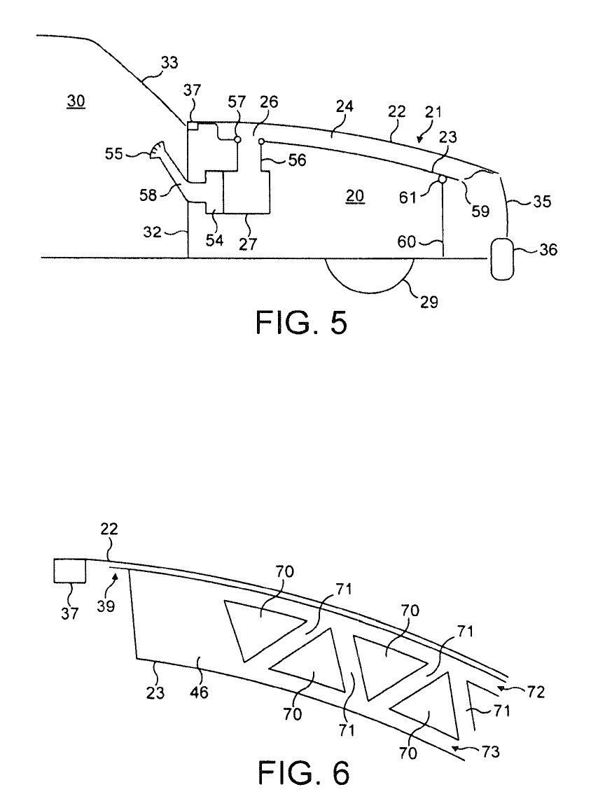

In more detail, the vehicle of FIG. 2 comprises an engine which can drive wheels 29 to rotate. The vehicle of FIG. 2 is rear-engined, so the engine is not visible in the figures. A passenger compartment 30 includes seats for occupants and operating controls for use by the driver to control the operation of the vehicle. The front of the passenger compartment is bounded by a bulkhead 32 (see FIG. 5), which separates it from the front compartment 20, and by a windscreen or windshield 33.

At the front of the vehicle the vehicle's bodywork comprises right and left wings 34, a front grille 35, a bumper or fender 36 and the bonnet 21. The bonnet can be raised and lowered on hinges 37. In its lowered position the upper side edges of the bonnet sit level with the upper and inner edges of the wings, although there is a slight panel gap between the bonnet and the wings, as illustrated at 38 in FIG. 3. When the bonnet is in its raised position the interior of the compartment 20 is exposed. The outer surface of the bonnet is generally planar, but it may be curved, folded or otherwise shaped for aerodynamic, aesthetic or other reasons. The bonnet will typically slope down towards the front when it is closed; thus when the bonnet is closed and the vehicle is on a level surface the forward end of the bonnet will typically be lower than the rear end.

In a bonnet that is not attached to a vehicle, the sides can sometimes be identified by the fact that hinges or attachment points for hinges are attached on the rear edge which in such bonnets is generally perpendicular to the sides; or can sometimes be identified by the fact that some bonnets are intended to be generally symmetrical about the mid-line of the vehicle they are to be mounted to, which is generally parallel to the sides of the bonnet. Of course, the bonnet (or other body panel) could have one or more hinges attached along any edge of the bonnet.

The bonnet is made up of two sheets of material 22, 23. The upper sheet 22 is sized to extend roughly from one wing 34 to the other in the lateral (“Y”) direction and from the windscreen 33 to the grille 35 in the longitudinal (“X”) direction. The upper surface of the upper sheet 22 defines the outer surface of the bonnet when it is closed. The lower sheet 23 is somewhat smaller than the upper sheet. The lower sheet is bonded around its periphery to the upper sheet, as shown at 39. Two central portions of the lower sheet are also bonded to the upper sheet, as shown at 40. The regions of the lower sheet near the locations where it is bonded to the upper sheet extend away from the upper sheet, with the result that the remaining area of the lower sheet is spaced from the upper sheet. In this way, the two sheets define the cavity 24 between them.

The cavity encircles the two central bonded portions 40 and is bounded by the peripheral bonding 39. The cavity comprises two side channels 41, 42 which run length-wise along the bonnet near the edges of the inner sheet 23; a central channel 43 which runs length-wise along the bonnet near the middle of the inner sheet 23; a rear channel 44 which runs width-wise across the bonnet, connecting the rear-most ends of the side channels and the central channel; and a front channel 45 which runs width-wise across the bonnet, connecting the front-most ends of the side channels and the centre channel. The sides of the channels are defined by the portions of the lower sheet 23 that extend away from the upper sheet. Those portions extend out of the general plane of, the upper sheet and the major part of the lower sheet, and roughly perpendicular to those sheets.

The outer sides 46, 47 of the side channels 41, 42 are perforated so as to form grilles which define the air intakes 25. A portion of the lower sheet 23 is cut away to form an aperture which defines air outlet 26. Outlet 26 opens onto the intersection of the rear part of the central channel 43 and the rear channel 44. Air can flow from the grilles 25 to the aperture 26 via two routes. One route goes rearwardly along the side channels and centrally across the rear channel. The other route goes forwardly along the side channels, centrally along the front channel and rearwardly along the central channel.

The air handling system comprises an air conditioning pack 27, including a blower 54 and a cabin air vent 55. A first duct 56 is located in the cavity 20. The upper end of duct 56 is exposed when the bonnet is open and is positioned so as to mate with aperture 26 when the bonnet is closed. To that end the upper end of the first duct 56 and/or the periphery of aperture 26 may be equipped with a resilient seal 57 to resist air leakage between the two. The lower end of duct 56 is attached to the input of the air conditioning pack 27. The outlet of air conditioning pack 27 is at the outlet of the blower 54. The outlet of the blower 54 is attached to a second duct 58 which runs through the bulkhead 32 to the vent 55. The operation of the air conditioning pack and the blower can be controlled by the vehicle's driver.

When the bonnet is closed, air can be drawn in from the cavity 20 through the grilles 25, can pass through the channels in the bonnet to the aperture 26, and through the duct 56, air conditioning pack 27, blower 54, duct 58 and vent 55 into the cabin 30. Air can flow in to cavity 20 through any available inlets, but for instance through the panel gaps such as 38 around the bonnet. In this situation the cavity 24 in the bonnet performs at least three air handling functions. First, the cavity 24 serves to channel the air from the intakes 25 towards the outlet 55. Second, the cavity 24 serves as a plenum to buffer the air conditioning pack 27 and the cabin 30 against sudden changes in pressure of the intake air. Third, the cavity 24 serves to extract water from the intake air. Water in the intake air can fall out in the cavities, drain down the upper surface of the lower sheet 23 and exit the cavities through a small drain hole 59 in the wall of the front channel 45. By integrating the plenum into the bonnet in this way the plenum can conveniently be provided without occupying otherwise useful space in the compartment 20.

The drain hole 59 is preferably located at the lowest point of the system of channels in the bonnet when the bonnet is closed and the vehicle is on a level surface. It is undesirable for water dripping from the drain hole 59 to enter the compartment 20. For this reason, there is preferably a lateral wall 60 which bounds the front of the compartment 20 and has a seal 61 on its upper surface which is located to seal with the underside of the bonnet when the bonnet is closed. The drain hole 59 is preferably sited so that when the bonnet is closed it is on the side of this seal opposite the compartment 20. To accommodate this, the channel in which the drain is sited is preferably in the front half of the bonnet, and most preferably in the front third. Similarly, the drain hole 59 is preferably sited in the front third of the bonnet, more preferably in the front quarter and most preferably in the front fifth. The air outlet is preferably spacer rearwardly from the drain hole by a substantial distance, for example half the length of the bonnet or more, in order to promote the extraction of water before air reaches the outlet.

The depth of the plenum is preferably relatively shallow, in order not to extend excessively into the vehicle. For example, it may have a maximum depth of less than 100 mm or less than 60 mm. The depth of the plenum is preferably considerably less than its other dimensions, so the plenum is preferably of a generally flat configuration. The depth of the plenum could advantageously be less than one fifth or one eighth of the body panel's (e.g. bonnet's) height and width. In this way, the presence of the plenum does not disrupt the normal design considerations associated with the provision of a bonnet or other body panel. Preferably the walls that define the plenum provide the major contribution to the stiffness of the body panel, so that preferably other stiffening means are not present.

The twin-walled bonnet structure as described above performs further functions. The upper wall 22 defines the bonnet as seen from the exterior of the vehicle, but by itself the upper wall has little rigidity. Because the lower wall 23 has portions extending out of the general plane of the bonnet, bonding that lower wall to the upper wall strengthens the overall bonnet structure. Most preferably, the lower wall 23 is a structural component of the bonnet, which substantially resists flexion of a substantial portion of, and preferably of the majority of, the surface of the bonnet. At the same time, the walls 22 and 23 co-operate to define by means of their facing surfaces the boundaries of the cavity or plenum that performs the air handling functions described above.

In addition, it is desirable for the bonnet to be able to deform relative to the remainder of the vehicle if it is hit by a pedestrian. The presence of the grilles 25 in the side-walls 46, 47 weakens those walls. The vents 25 can be designed so as to allow the bonnet to deform plastically in a controlled fashion if it is hit by a pedestrian. Thus, the vents 25 can serve the purpose of acting as air intakes and also the purpose of improving the crash-worthiness of the bonnet. Depending on the design of the vehicle, configuring the bonnet so it can deform in this way may avoid the need for frangible or deformable hinges mounting the bonnet to the vehicle body.

FIG. 6 shows one way in which the side walls of the bonnet can be configured for controlled deformability. In this example the grilles 25 are formed by triangular holes 70 in the side wall 46. Thin webs 71 separate the holes 70 and extend between the upper rim 72 of side wall 46 and the lower rim 73 of side wall 46. Those thin webs provide a degree of stiffness to the bonnet but are sufficiently insubstantial that they can deform in the event of a collision with a pedestrian, allowing the bonnet to flex or collapse plastically. Other designs of grille could be used. The grilles could be constituted by additional components which attach, for example by clipping, over a larger hole in the side walls 46, 47.

The intakes 25 to the HVAC system draw air from under the bonnet. That air could reach the intakes through the panel gap 38 between the bonnet and the wings or through other spaces. Positioning the intakes as shown in the figures has a number of advantages. First, because they are offset sideways from gaps 38 they are protected by the wings and the bonnet from water ingress. If water splashes over the front of the car then it is likely to fall downwards from gap 38 rather than go sideways from gap 38 to vents 25. Second, because they are substantially parallel with the longitudinal axis of the vehicle and out of the main flow of air over the vehicle they tend to draw in air at atmospheric pressure rather than having air pushed into them when the vehicle is in motion. This can allow the air conditioning pack to operate more efficiently.

As described above, air can flow from the grilles 25 to the aperture 26 via two routes. One route goes rearwardly along the side channels and centrally across the rear channel. The other route goes forwardly along the side channels, centrally along the front channel and rearwardly along the central channel. In some vehicles, the availability of the first route might allow water to pass from the intakes 25 to the outlet 26. In such a design, the first route could be blocked or restricted, for example by making the upper channel 44 thinner between the outer channels and the central channel, or by installing barriers in the upper channel between the outer channels and the central channel as indicated by dashed lines at 80 in FIG. 2. It is advantageous that the channels 41 and 43 run along a significant proportion of the length of the bonnet, preferably more than half its length. In this way the intakes 25 can be made relatively large, so as not to resist inflow of air, and the path along which the air flows from the intakes to the outlet 26 via the first channel can be made relatively long so that extraction of water from the air is enhanced.

The sheets 22, 23 of which the bonnet is made could be formed of any suitable material or of different materials. Examples include steel, aluminium alloy, plastics sheet and composites such as carbon fibre. They could be bonded together by any suitable technique, for example welding or adhesive. The sheets could be shaped by any suitable process, for example pressing or moulding. The holes that define the intakes 25 and the outlet 26 could be punched into the sheets or moulded at the time the sheets are formed. The bonnet could be moulded in a single piece which defines both sheets, in which case no bonding would be needed.

The arrangements described above relate to a bonnet at the front of a vehicle. Similar arrangements could be applied to other vehicle panels, whether or not they are hinged or otherwise moveable relative to the body of the vehicle. For example, they could be applied to boot or trunk lids at the rear of a vehicle, door panels, wing panels or roofs. However, the arrangements are especially useful when applied to bonnets since cabin air is normally taken in at the front of a vehicle, and since it is desirable for the bonnet of a vehicle to be especially well adapted to deform safely in the event of an impact with a pedestrian. The principles described above could be applied to vehicles other than cars, for example to other road-going vehicles or to non-road-going vehicle such as boats.

The air taken in through the system could be used for purposes other than supplying air-conditioned cabin air. For example, it could pass to a simple heater matrix rather than an air conditioning pack and then into the cabin, or even just straight into the cabin without any heating. It could be used for purposes such as cooling or ventilating electronic or mechanical equipment in the vehicle, whether or not that is located in the cabin.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. An air intake system for a vehicle, the system comprising
a body panel having:
an exterior face; and
a pair of opposed walls defining an interior plenum therebetween, the walls defining a major sheet and a minor sheet generally parallel to a general plane of the major sheet, and being attached together by webs extending between the major sheet and the minor sheet in a direction out of a general plane of the major sheet in such a way as to structurally stiffen the body panel;
the plenum having;
an air intake located in a side wall of the plenum in one or more of the webs inboard of the periphery of the major sheet for admitting air into the plenum; and
an air outlet for supplying air to an air handling system of a vehicle.

2. An air intake system as claimed in claim 1, wherein the body panel has a front edge, a rear edge and side edges extending between the front and rear edges.

3. An air intake system as claimed in claim 2, wherein there is a drain hole in the plenum at a point near the front edge.

4. An air intake system as claimed in claim 2, wherein the body panel is a bonnet for a vehicle and wherein the wall defining the major sheet provides said exterior face.

5. An air intake system as claimed in claim 2, wherein the plenum comprises at least two longitudinal channels extending in a direction between the front and rear edges and a lateral channel interconnecting the longitudinal channels.

6. An air intake system as claimed in claim 5, wherein there is a drain hole in the plenum at a point near the front edge.

7. An air intake system as claimed in claim 5, wherein the body panel is a bonnet for a vehicle and wherein the wall defining the major sheet provides said exterior face.

8. An air intake system as claimed in claim 5, wherein the lateral channel interconnects the longitudinal channels at the ends of the longitudinal channels nearest the front edge.

9. An air intake system as claimed in claim 8, wherein there is a drain hole in the plenum at a point near the front edge.

10. An air intake system as claimed in claim 9, wherein the body panel is a bonnet for a vehicle and wherein the wall defining the major sheet provides said exterior face.

11. An air intake system as claimed in claim 1, wherein the body panel is a bonnet for a vehicle and wherein the wall defining the major sheet provides said exterior face.

12. A vehicle having an air intake system as claimed in claim 1, panel forming a part of the vehicle's exterior.

13. A vehicle as claimed in claim 12, wherein the body panel is a bonnet of the vehicle.

14. A vehicle as claimed in claim 13, wherein the air outlet is near the rear of the bonnet.

15. A vehicle as claimed in claim 13, wherein the bonnet is mounted on the vehicle so that when the vehicle is in its running configuration the air inlet is not visible from the exterior of the vehicle.

16. A vehicle as claimed in claim 13, wherein the plenum comprises at least two longitudinal channels extending in a direction between the front and rear edges and a lateral channel interconnecting the longitudinal channels and wherein the bonnet is mounted on the vehicle so that when the vehicle is in its running configuration the longitudinal channels slope down from the rear of the bonnet to the front.

17. A vehicle as claimed in claim 13, wherein the body panel is formed of sheet material and the air intake is formed of one or more apertures through the sheet material, the apertures providing for controlled deformability of the bonnet in a crash.

18. A vehicle as claimed in claim 17, wherein the plenum comprises at least two longitudinal channels extending in a direction between the front and rear edges and a lateral channel interconnecting the longitudinal channels and wherein the bonnet is mounted on the vehicle so that when the vehicle is in its running configuration the longitudinal channels slope down from the rear of the bonnet to the front.

19. A vehicle as claimed in claim 17, wherein the bonnet is mounted at the vehicle by means of one or more hinges which are not designed to fail or deform in the event of a collision with a pedestrian, the apertures instead being configured to plastically deform in the event of such a collision.

20. A vehicle as claimed in claim 19, wherein the plenum comprises at least two longitudinal channels extending in a direction between the front and rear edges and a lateral channel interconnecting the longitudinal channels and wherein the bonnet is mounted on the vehicle so that when the vehicle is in its running configuration the longitudinal channels slope down from the rear of the bonnet to the front.
